(19) United States
(12) Patent Application Publication
(10) Pub. No.: US 2011/0155982 A1
(43) Pub. Date: Jun. 30, 2011

(54) METAL FENCE ASSEMBLY WITH CONCEALED CONNECTION AND MANUFACTURING METHOD

(76) Inventors: Gordon DUFFY, Fair Play, SC (US); Jason DUFFY, Jefferson, GA (US)

(21) Appl. No.: 12/650,593

(22) Filed: Dec. 31, 2009

(51) Int. Cl. E04H 17/14; B23P 11/00

(52) U.S. Cl. 256/22; 29/428

(57) ABSTRACT

A fencing/railing assembly adapted to be positioned between a pair of posts and mounted thereto. The assembly includes a plurality of elongate pickets and one or more rails extending transverse to the pickets. The pickets each have at least one protrusion formed or positioned thereon. The rails have an elongate channel formed on an inside portion thereof for cooperating with the protrusion. The rails further include picket openings formed in an upper portion thereof for receiving pickets therethrough. The picket openings are sized and adapted to be slipped over the pickets and securely held in place by engagement of the protrusions with the channels formed on the inside portion of the rails. The channels and the protrusions form a connection between the pickets and the rails.

### BACKGROUND OF THE INVENTION

The present invention relates to fencing and railings, and in particular relates to metal fencing and metal railings.

### SUMMARY OF THE INVENTION

Briefly described, in a first preferred form the present invention relates to a fencing/railing assembly adapted to be positioned between a pair of posts and mounted thereto. The assembly includes a plurality of elongate pickets and one or more rails extending transverse to the pickets. The pickets each have at least one protrusion formed or positioned thereon. The rails have an elongate channel formed on an inside surface thereof for cooperating with the protrusion. The rails further include picket openings formed in an upper portion thereof for receiving pickets therethrough. The picket openings are sized and adapted to be slipped over the pickets. The pickets are securely held in place with the rails by the engagement of the protrusions on the pickets with the channels formed on the inside surfaces of the rails. The channels and the protrusions form a connection between the pickets and the rails.

Preferably, the fencing/railing assembly, including the pickets and the rails, comprises aluminum extrusions. Alternatively, the fencing/railing assembly can be made of partly or completely of plastic. Also preferably, the rails are generally U-shaped extrusions and have picket openings formed in one portion thereof for receiving the pickets therethrough. Optionally, a leading, inner edge of the rail is beveled or chamfered to facilitate slipping the rail over the protrusion while the rail is slid onto the pickets.

In another preferred form, the present invention comprises a method of manufacturing a fencing/railing assembly to be positioned between a pair of posts and mounted thereto. The method comprises the steps of (a) providing a series of pickets with connector protrusions formed therein, (b) providing at least one generally U-shaped rail with picket recesses formed on an upper portion thereof and with a channel formed on an inside surface thereof for cooperating with the protrusions, and (c) slipping the U-shaped rails over the pickets to engage the protrusions in the channel to secure the rail to the pickets and conceal the connection between the rail and the pickets.

### BRIEF DESCRIPTION OF THE DRAWINGS

FIG. 1 is a front elevation view of a fencing/railing assembly according to a preferred form of the present invention.

FIGS. 2A-2C are side elevation, front elevation, and perspective views of a component of the fencing/railing assembly of FIG. 1.

FIG. 3 is a perspective sectional view of a component of the fencing/railing assembly of FIG. 1.

FIG. 4 is a schematic perspective sectional view of the fencing/railing assembly of FIG. 1 (not to scale).

FIGS. 5A-5C are side elevation section views of the fencing/railing assembly of FIG. 1, depicting how the fencing/railing assembly is assembled.

FIGS. 6A-6C are side cross-section views of a component of a fencing/railing assembly according to a second embodiment, depicting how the component can be manufactured.

FIG. 7 is a side sectional view of a component of a fencing railing assembly according to a third embodiment, depicting how the component can be manufactured.

### DETAILED DESCRIPTION

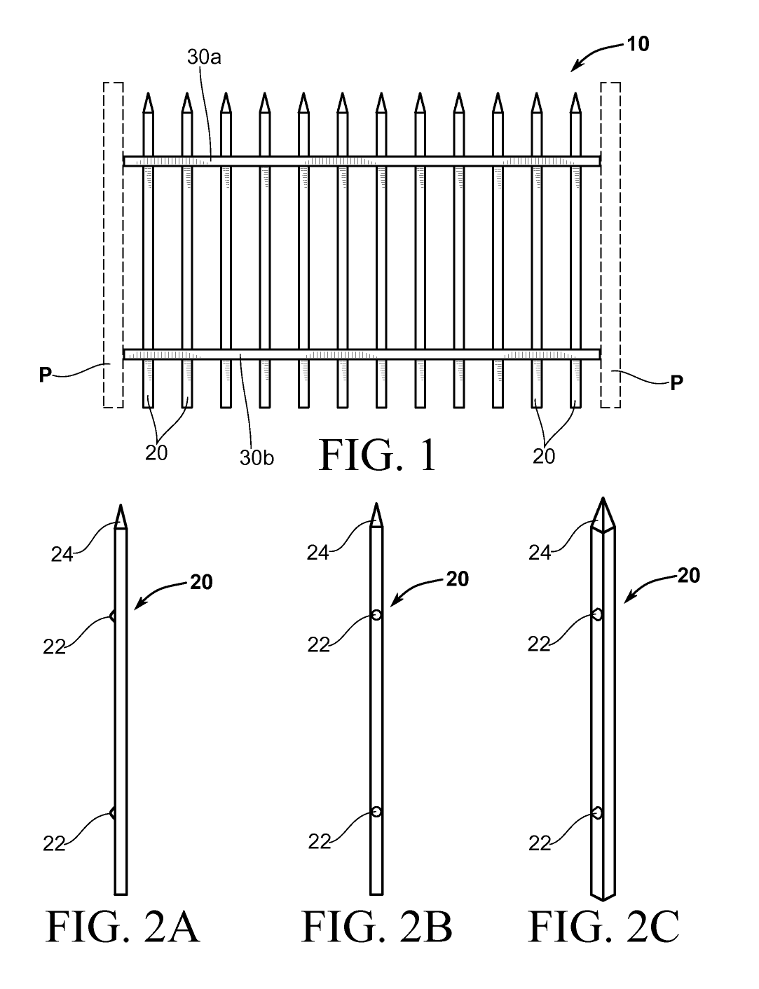

Referring now in detail to the drawing figures, wherein like reference numerals represent like parts throughout the several views, FIG. 1 shows a fencing and/or railing assembly 10 according to a preferred example embodiment. As depicted, the assembly 10 can be used to enclose yard spaces, decks, porches and the like. The fencing/railing assembly 10 is shown spanning and mounted between two posts P. Generally, the railing assembly 10 comprises a plurality of horizontally spaced pickets 20 and at least one horizontal support rail 30. In depicted example embodiments, the railing assembly comprises two support rails 30a, 30b (as seen in FIG. 1) to space, align, and secure the pickets 20 and to provide for structural rigidity. Each picket 20 can include an endcap 24 coupled to the top of the same (or formed in the top portion itself) to close off the top of the picket and/or to provide a decorative element to the railing assembly 10. In example embodiments, the pickets 20 and railings 30a, 30b are formed from extruded aluminum; however, in alternative embodiments, the pickets and railing can be formed from solid aluminum, other metals and/or metal alloys, wood, rubber, plastic, and/or other materials known in the art. In example embodiments, the pickets 20 are square aluminum extrusions and the railings 30 roughly rectangular aluminum extrusions (but U-shaped); however, in alternative embodiments, the pickets and railing can be formed into different shapes.

As seen in FIGS. 2A, 2B, and 2C, the picket 20 typically is an elongate structure having at least one protrusion 22 formed or positioned thereon and an endcap 24. The at least one protrusion 22 is preferably horizontally centered on the front face of the picket 20. The at least one protrusion 22 can be located at any desired vertical level on the picket 20. Preferably, as shown there are two such protrusions 20 on each picket, one for each rail. In this example embodiment depicted there are a total of twelve pickets 20 shown in the fencing/railing assembly 10 in FIG. 1, but in other embodiments, there can be more or fewer pickets 20.

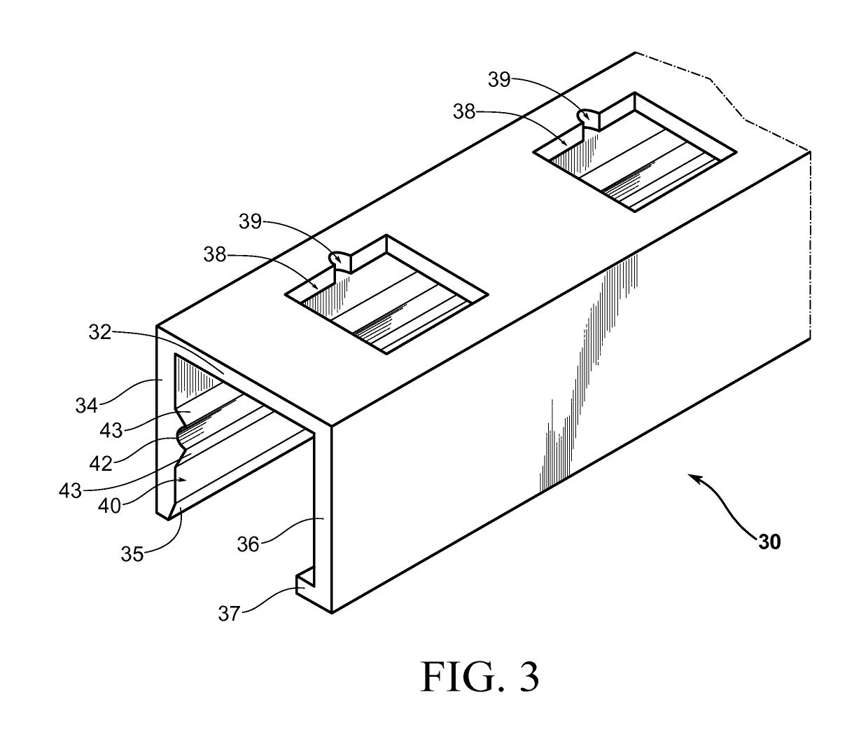

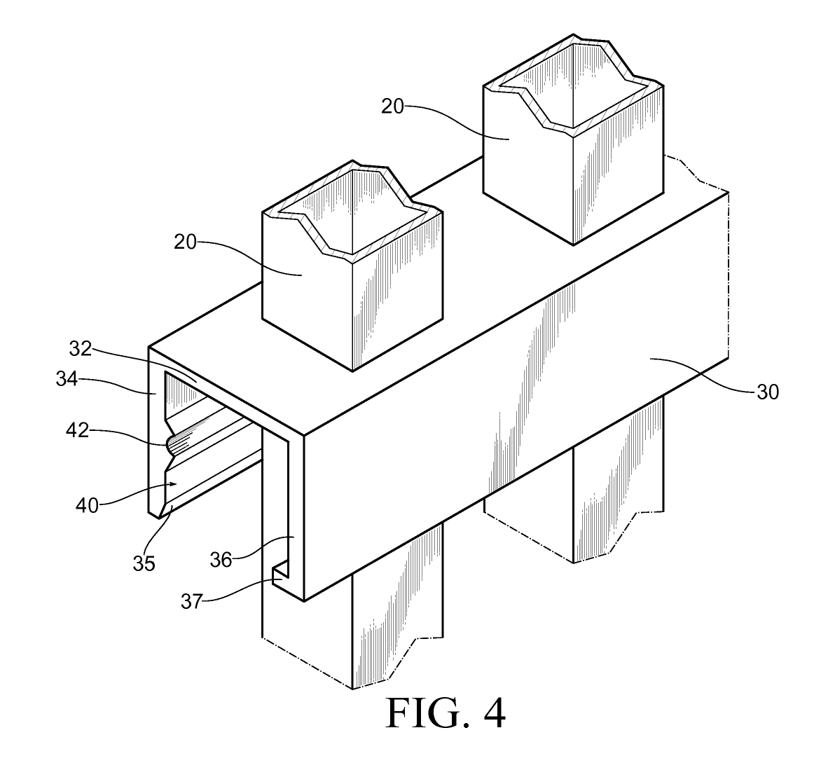

As seen in FIGS. 3 and 4, the rails 30 have a substantially “U” shaped cross-section and generally in use are oriented open-side-down such that the “bottom” of the “U” forms the top of the rail 30. In alternative embodiments, the rails 30 can have a substantially “J” shaped cross-section or rectangular shaped cross-section. In still other embodiments, the rails 30 can include other cross-sections as desired. As shown in FIGS. 3 and 4, the rails 30 include an upper portion 32, a first descending portion 34, and a second descending portion 36. The portion 34 extends downwardly from the one end of the upper portion 32 and portion 36 extends downwardly from the opposite end of the upper portion 32, resulting in the aforementioned open-side-down “U” shaped cross-section of the rail 30. The lower leading edge 35 of the portion 34 optionally can be chamfered or beveled or radiused to facilitate a smooth movement as the rails 30 are slid over the pickets 20 as the fencing/railing assembly 10 is assembled. Furthermore, the lower leading edge of the portion 36 optionally can have a foot or toe 37 extending perpendicularly therefrom that rests against the rear face of the picket 20 and provides structural rigidity for the fencing/railing assembly 10 when the rail 30 is assembled with the pickets 20.

The descending portion 34 has an inner face 40. An elongate channel 42 is formed along the inner face 40. In this example embodiment, the elongate channel 42 is a raised semicircular groove or slot or shallow trough 42 extending along the axis of elongation of the rail 30. The semicircular groove 42 is flanked on both sides by two ramp surfaces 43, 44. The ramp surfaces 43, 44 allow the protrusions 22 on the pickets 20 to slide more easily into engagement with the channel 42 as the fencing/railing assembly 10 is assembled.

The upper portion 32 of the rail 30 includes a plurality of picket openings 38, sized, shaped and adapted to receive the plurality of pickets 20 therethrough. The picket openings 38 in this example embodiment are square cutouts or apertures, dimensioned to provide a somewhat snug and secure fit around the pickets 20, which have a square cross-section. In other embodiments, the picket openings 38 can be dimensioned to provide a slightly loosened fit around the pickets 20 in order to allow the pickets 20 to pivot slightly when assembled with the rails 30, allowing the fencing/railing assembly 10 to be installed on a sloped or angled surface with a vertically plumb orientation (to rack). The picket openings 38 optionally can have a slit or cutout 39 centered on the leading surface of the picket opening 38. The cutout 39 is shaped to match the profile of the protrusion 22 on the picket 20, allowing the protrusion 22 to pass through the cutout 39 as the rail 30 is slid vertically over the picket.

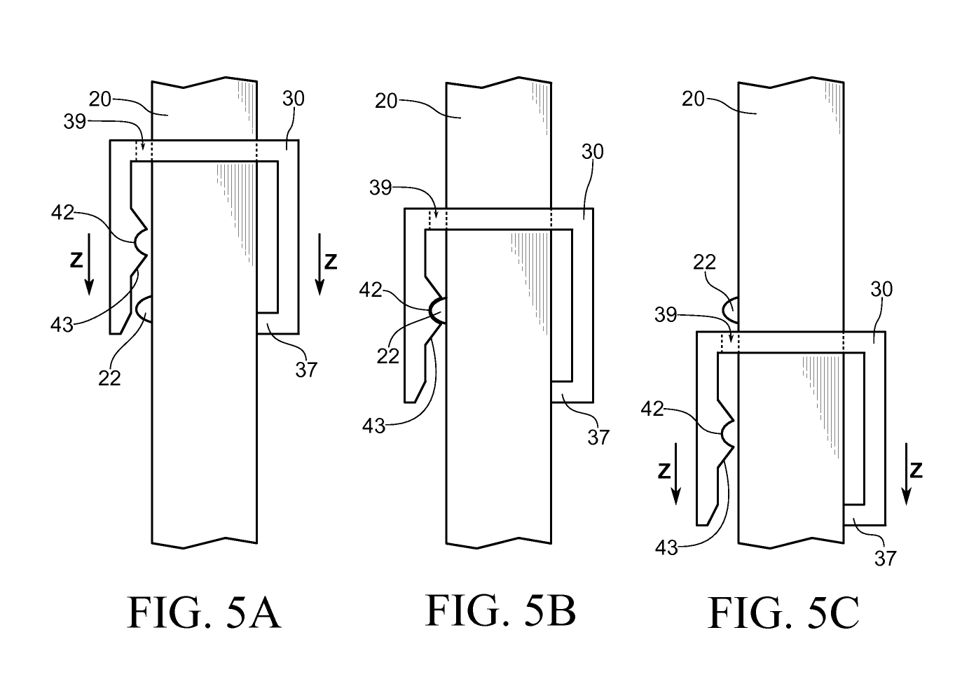

FIGS. 5A, 5B, and 5C show how the rail 30 is slid onto and installed on the picket 20. FIG. 5A shows the rail 30 sliding downwardly over the picket 20, as denoted by the direction arrows Z. The rail 30 is positioned over the pickets 20 such that the first portion 32 of the rail 30 is adjacent the front side of the pickets 20. As the rail 30 is slid down the picket 20, the upper portion of the protrusion 22 comes into contact with the lower ramped surface 43, traversing upwardly on the ramped surface 43. The first portion 32 of the rail 30 is then slightly forced slightly outwardly away from the picket 20, allowing the protrusion 22 to engage with the channel 42 on the rail 30.

In alternative embodiments, wherein when there is more than one rail 30 to be assembled onto the fencing/railing assembly 10, the picket openings 38 can optionally have cutouts 39, centered on the leading surface of the picket openings 38. The protrusions 22 can be engaged with the channel 42, as seen in FIG. 5B, and installed as mentioned before, and then slid further down along the pickets 20. The protrusions 22 pass through the cutouts 39, and the rail 30 then is in the position as depicted in FIG. 5C. The rail 30 is then moved downwardly in the direction denoted by the direction arrows Z in FIG. 5C, allowing them to be installed on other protrusions farther down on the pickets 20. A lower rail 30 optionally can be installed on the pickets 20 by passing it up over the bottom of the pickets 20, sliding the rail 30 up the pickets 20, and having the protrusions 22 pass through the cutouts 39. The protrusions 22 would then be able to engage with the channel 42 by push portion 32 slightly away from the pickets 20, sliding the rail 30 upwards along the pickets 20, and having the protrusions 22 engage with the channel 42.

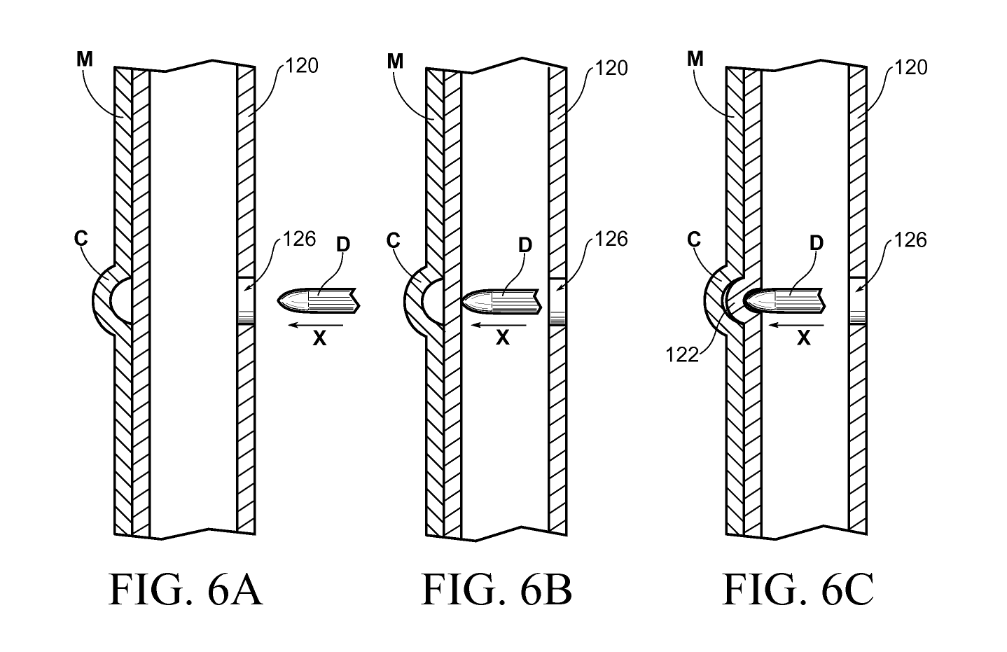

A picket manufacturing technique is shown in FIGS. 6A, 6B, and 6C. A picket 120 having an elongate body has an aperture 126 formed on its trailing face. The leading portion of the picket is placed against a die or mandrel M with an impression mold C. The impression mold C in this embodiment is formed in the shape of a cup or semisphere. A punch D is provided and inserted through the aperture 126, moving in the direction denoted by the direction arrow X as shown in FIGS. 6A, 6B, and 6C. The die D comes into contact with the trailing surface of the leading side of the picket 120, as depicted in FIG. 6B, presses against the leading side of the picket 120, and leaves the leading portion of the picket 120 with a cold-worked protrusion 122 using the impression mold C, as shown in FIG. 6C.

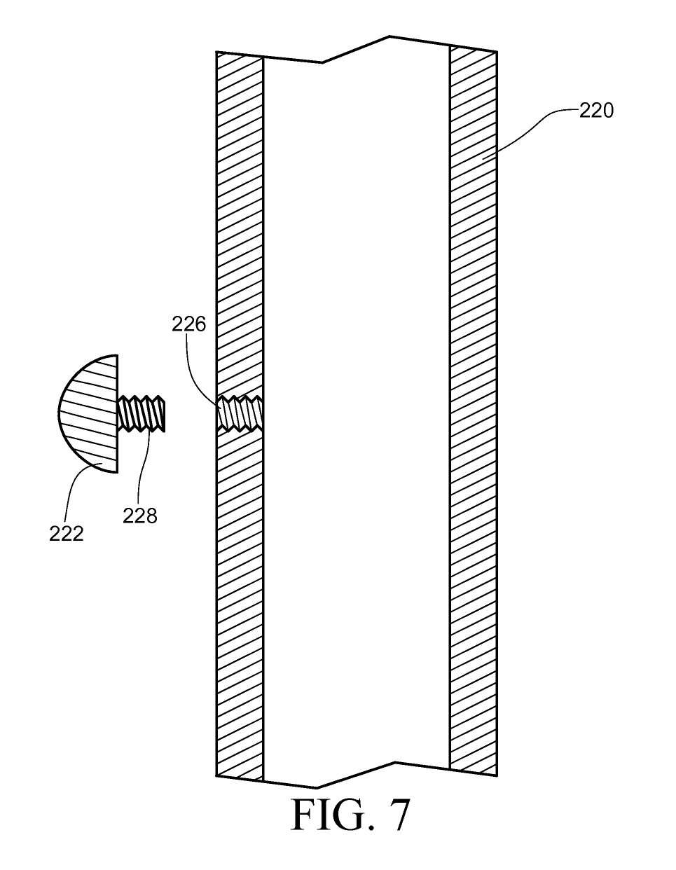

FIG. 7 shows an alternative picket manufacturing technique. A picket 220 having an elongate body is shown with an aperture 226 formed on the leading side of the picket 220. The aperture 226 has female internal threads formed on its inner surface. A protrusion or nub 222 is provided, having a male connector element 228 attached thereto. The male connector element 228 has external threads formed on its outer surface. In use, the male connector element 228 is screwed into the aperture 226, securing the protrusion 222 to the picket 220. There can be one or more apertures 226 on the picket 220 for receiving one or more protrusions 222 therein.

In manufacturing the assembled product, a simplified technique or method is accomplished. The fencing/railing assembly can be provided as a fully pre-assembled fence or as separate components to be assembled by an end user. In a preferred method, the manufacturing method for constructing the fencing/railing assembly comprises the steps of:

(a) providing a series of pickets with connector protrusions formed therein;

(b) providing at least one generally U-shaped rail with picket recesses formed on an upper portion thereof and with a channel formed on an inside portion of the U-shaped rail for cooperating with the protrusions; and

(c) slipping the U-shaped rail over the pickets to engage the protrusions in the channel to secure the rail to the pickets and conceal the connection between the rail and the pickets. The manufacturing method described above allows for easy and economical manufacture, as well as providing a consistently good manufacturing quality. Also, when the fencing/railing assembly is fully assembled, the protrusions on the pickets are not visible (are concealed).

While the invention has been described with reference to preferred and example embodiments, it will be understood by those skilled in the art that a variety of modifications, additions and deletions are within the scope of the invention, as defined by the following claims.

What is claimed is:

1. A metal fencing/railing assembly adapted to be positioned between a pair of posts and mounted thereto, the assembly comprising:
a plurality of elongate metal pickets, the pickets each having at least one protrusion formed or positioned thereon, and
one or more metal rails extending transverse to the pickets and having an elongate channel formed on an inside surface thereof for cooperating with the protrusion, the rails having picket openings formed in an upper portion thereof for receiving pickets therethrough and being sized and adapted to be slipped over the pickets and securely held in place by engagement of the protrusions on the pickets with the channels formed on the inside surfaces of the rails, wherein the channels and the protrusions form a connection between the pickets and the rails.

2. A fencing/railing assembly as claimed in claim 1 wherein the rails comprise metal extrusions and wherein a lower, leading edge of the rails is beveled or chamfered to ease the rail over the protrusions to assist in the protrusions reaching the channels.

3. A fencing/railing assembly as claimed in claim 2 wherein the rails are generally U-shaped.

4. A fencing/railing assembly as claimed in claim 1 wherein the protrusion comprises a nub formed in the picket.

5. A fencing/railing assembly as claimed in claim 1 wherein the protrusion comprises a protuberance attached to the picket.

6. A fencing/railing assembly as claimed in claim 1 wherein the pickets and the rails comprise aluminum extrusions.

7. A fencing/railing assembly as claimed in claim 6 wherein the pickets have a rectangular cross section.

8. A fencing/railing assembly as claimed in claim 1 wherein, when assembled, the connection between the rails and the pickets is not readily visible.

9. fencing/railing assembly as claimed in claim 1 wherein the channels and the protrusions have corresponding, matching profiles to securely receive the protrusions in the channels.

10. A method of manufacturing a fencing/railing assembly to be positioned between a pair of posts and mounted thereto, the method comprising the steps of:
providing a series of pickets with connector protrusions formed therein;
providing at least one generally U-shaped rail with picket recesses formed on an upper portion thereof and with a channel formed on an inside surface thereof for cooperating with the protrusions; and
slipping the U-shaped rail over the pickets to engage the protrusions in the channel to secure the rail to the pickets and conceal the connection between the rail and the pickets.
